(19) United States
(12) Patent Application Publication
(10) Pub. No.: US 2024/0132065 A1
(43) Pub. Date: Apr. 25, 2024

(54) METHOD AND DEVICE FOR OPERATING A PARKING ASSISTANCE SYSTEM, PARKING GARAGE, AND VEHICLE

(71) Applicant: Valeo Schalter und Sensoren GmbH, Bietigheim-Bissingen (DE)

(72) Inventor: Luc Jansseune, Creteil (FR)

(73) Assignee: Valeo Schalter und Sensoren GmbH, Bietigheim-Bissingen (DE)

(21) Appl. No.: 18/275,296

(22) PCT Filed: Jan. 26, 2022
(86) PCT No.: PCT/EP2022/051667

§ 371 Date: Jul. 31, 2023

(30) Foreign Application Priority Data
Feb. 2, 2021 (DE) 10 2021 102 299.1

(51) Int. Cl. B60W 30/095; B60W 30/06

(52) U.S. Cl. CPC B60W 30/0956; B60W 30/06; B60W 2050/0008; B60W 2420/403; B60W 2420/408

(57) ABSTRACT

A method for operating a parking assistance system (105) for a vehicle (100) is proposed. The method comprises: a) projecting (S1) a predetermined pattern (PAT1-PAT6) onto a predetermined area (205), especially an area (205) by the vehicle (100), b) capturing (S2) an image, with at least a portion of the predetermined area (205) with the projection (220) being visible in the captured image, c) determining (S3) an object (210) arranged in the predetermined area (205) on the basis of the captured image, and d) updating (S4) a digital map of the surroundings (MAP0, MAP1) using the captured object (210).

The present invention relates to a method and to a device for operating a parking assistance system for a vehicle, a parking garage having such a device, and a vehicle.

To make a parking process for a user of a vehicle more efficient, it is desirable to automate the parking. This can be designated as automated valet parking. In this case, the user transfers the vehicle at a transfer point to the automated valet parking system, which takes over the control of the vehicle and controls the vehicle autonomously to a free parking space and parks it there. The user can accordingly also take over the vehicle again at the transfer point. Such an automated valet parking system uses, for example, sensors arranged externally to the vehicle, in particular cameras, radar devices, and/or lidar devices, to capture the vehicle and the surroundings of the vehicle. Control signals are output to the vehicle on the basis of the captured data and the vehicle is controlled in this manner. These systems are advantageous not only for the user, but also for operators of parking garages or parking areas, since a space utilization can be optimized. Furthermore, any remote-controllable vehicle can be used in such a system, the vehicle itself does not require complex technology for surroundings capture and control.

One known problem in such systems is that smaller and/or moving obstacles, in particular living beings, such as children or animals, are only captured poorly or inaccurately by the sensors. To nonetheless ensure a sufficient level of safety, a very high level of technical expenditure has to be made, for example, very many cameras are used, which makes the system very complex and costly.

If the vehicle itself has sensors for capturing its surroundings and an autonomous control unit, the vehicle can drive autonomously. For automated valet parking, the knowledge of a map of the parking area or the parking garage is additionally necessary, since otherwise the control unit has no orientation. Even if such a map is provided, for example, when the vehicle enters the parking area or the parking garage, locating of the vehicle is only to be achieved using complex means. In particular, notifications or signs which can be captured by the sensors and which identify a unique position on the parking area or in the parking garage have to be arranged in a distributed manner. Locating by means of GPS or the like is not possible or is not possible with sufficient accuracy inside buildings, particularly if the parking garage has multiple stories, which are arranged one over another.

US 2020/0209886 A1 discloses a system and a method, in which laser scanners arranged on a ceiling of a parking garage project a path on a roadway, which is used to guide the autonomous vehicle.

Against this background, one object of the present invention is to improve the operation of a parking assistance system for a vehicle.

According to a first aspect, a method for operating a parking assistance system for a vehicle is proposed. The method comprises the steps of:
a) projecting a predetermined pattern on a predetermined area, in particular an area by the vehicle,
b) capturing an image, wherein at least a portion of the predetermined area having the projection is visible in the captured image,
c) ascertaining an object arranged in the predetermined area in dependence on the captured image, and
d) updating a digital surroundings map using the captured object.

This method has the advantage that objects which are located in a lane of the vehicle can be captured with higher reliability and accuracy. A level of safety during the operation of the parking assistance system, in particular during autonomous driving of the vehicle, as in an automated parking process, can thus be increased.

The term “parking assistance system” is understood in the present case to mean any systems which assist and/or control the vehicle during a parking process, in particular during an autonomously performed parking process. The parking assistance system can comprise a unit integrated in the vehicle, can comprise a unit arranged in the infrastructure, for example a parking garage, and/or can comprise multiple units arranged in a distributed manner, which have a functional and/or communication connection with one another.

The parking assistance system is configured in particular for autonomously controlling and/or driving the vehicle. If the parking assistance system is arranged externally to the vehicle, this can also be referred to as remote control. The parking assistance system preferably has the automation level 4 or 5 according to the SAE classification system. The SAE classification system was published in 2014 by SAE International, a standardization organization for motor vehicles, as J3016, “Taxonomy and Definitions for Terms Related to On-Road Motor Vehicle Automated Driving Systems”. It is based on six different degrees of automation and takes into consideration the level of required intervention of the system and the required attention of the driver. The SAE degrees of automation extend from level 0, which corresponds to a completely manual system, via driver assistance systems in level 1 to 2 up to partially autonomous (level 3 and 4) and fully autonomous (level 5) systems, in which a driver is no longer necessary. An autonomous vehicle (also known as a driverless car, self-driving car, and robotic car) is a vehicle capable of sensing its surroundings and navigating them without human input, and conforms to SAE automation level 5.

First step a) of the method comprises projecting a predetermined pattern on a predetermined area. The predetermined area is, for example, an area in a parking garage. The predetermined area is in particular an area by the vehicle.

The predetermined pattern comprises optical features arranged in a predetermined manner, for example, lines arranged according to a geometrical rule, which can be straight or curved, and which can be open or can also form a closed shape. Examples of the predetermined pattern comprise a chessboard pattern, a rhomboid pattern, circles, triangles, wavy lines, and the like. Different ones of these patterns can be combined to form a new pattern. The predetermined pattern does not necessarily have to comprise lines as optical features, it can also be a point pattern or the like.

The predetermined pattern is preferably projected in such a way that a spacing of two adjacently arranged optical features, for example of two lines, of the pattern is between 5-30 cm, preferredly between 5-20 cm, preferably between 5-15 cm, more preferably less than 13 cm, still more preferably less than 11 cm. The closer the optical features are to one another, the smaller objects may be captured. However, the number of the optical features which are required to completely light up the area increases, and a required resolution in capturing the projection and a required computing performance for ascertaining the object increase.

In preferred embodiments, the predetermined pattern is designed in such a way that objects having a minimum size of 11 cm are captured by the pattern.

The predetermined pattern can be generated and projected by a projection unit, in particular a laser projector, arranged on the vehicle or externally to the vehicle in the infrastructure. The projection unit can comprise an LCD unit, a microlens array, and/or a micromirror array. The projection unit can be configured to scan a laser beam to project the predetermined pattern.

The predetermined area on which the pattern is projected comprises in particular a future lane or trajectory of the vehicle. The projection can be independent of a presence of the vehicle. The predetermined area is preferably located by the vehicle, however, for example in front of the vehicle or behind the vehicle. The area can also extend laterally around the vehicle. For example, the area extends multiple meters, for example five meters, in front of the vehicle. The area can in particular extend up to the vehicle and can comprise the vehicle (more precisely a projection of the vehicle on the ground).

It could be said that the area is scanned by the projection of the predetermined pattern.

The predetermined pattern is in particular projected at a wavelength from a spectral range of 250 nm-2500 nm. Depending on the embodiment of the projection unit, the pattern can be projected with a broadband spectrum, a narrowband spectrum, and/or a spectrum comprising multiple narrowband lines.

Second step b) of the method comprises capturing an image, wherein at least a portion of the predetermined area having the projection is visible in the captured image.

The image can be captured by a capture unit, in particular a camera, arranged on the vehicle or externally to the vehicle in the infrastructure.

The image is preferably captured using a specific minimum parallax in relation to the light beams which generate the projection. It is thus ensured that changes of the predetermined pattern due to objects located in the predetermined area may be ascertained with high reliability and accuracy.

Third step c) of the method comprises ascertaining an object arranged in the predetermined area in dependence on the captured image.

If an object is located in the area having the projection, the projection of the predetermined pattern is thus changed or influenced by the object. For example, shadowing occurs (i.e., individual optical features of the pattern are absent in some sections in the image of the projection), some sections of one or more of the optical features of the pattern are distorted (i.e., the affected optical features run at a point other than that expected in the image of the projection), and/or local variations of the intensity of the optical features occur due to a changed reflection angle.

The presence of an object can be ascertained with little computing effort on the basis of these changes of the predetermined pattern that can be captured in the image of the projection.

In embodiments, the captured image of the projection is compared to the predetermined pattern, wherein a change of the predetermined pattern is indicative of an object in the region of the projection.

Fourth step d) comprises updating a digital surroundings map using the captured object.

The digital surroundings map comprises in particular a digital representation of the actual surroundings of the vehicle. The digital surroundings map is preferably based on a map which reflects the structural conditions on location, such as a site plan, a building plan, or the like. The digital surroundings map can furthermore comprise moving objects, such as other road users, in particular other vehicles and pedestrians, which were captured by means of sensors. Furthermore, the digital surroundings map can comprise roadway markings and/or other traffic management instructions, which were captured by means of sensors. Moreover, the digital surroundings map can comprise items of information on an underlying surface, such as a composition, and the like.

The digital surroundings map in particular includes a coordinate system, the origin of which is, for example, permanently specified (world coordinate system) or the origin of which is fixed on a point of the vehicle.

The parking assistance system is in particular configured to carry out path planning for the vehicle on the basis of the digital surroundings map. That is to say, the parking assistance system plans the future trajectory for the vehicle on the basis of the digital surroundings map.

According to one embodiment of the method, step c) comprises:
capturing a distortion of the projected pattern in the captured image.

According to a further embodiment of the method, step a) comprises:
projecting the predetermined pattern using a laser projector.

According to a further embodiment of the method, step a) comprises:
projecting the predetermined pattern using a predetermined color, and step b) comprises:
capturing the image using a filter which is transparent for the predetermined color.

The predetermined color comprises, for example, one or more specific wavelength ranges. A respective wavelength range preferredly comprises a narrow range having a half-width of at most 20 nm, preferably at most 15 nm, more preferably at most 10 nm. The “specific color” can therefore comprise multiple narrow wavelength ranges, which correspond, for example, to emission lines of a laser or the like.

This embodiment has the advantage that a signal-to-noise ratio, at which the projection of the pattern can be captured by the capture unit, can be increased. This applies in particular if the filter used is a narrowband filter, which is only transparent for one or more narrow wavelength ranges.

The term “transparent” is understood in the present case to mean that the filter has a transmission of greater than 10%, preferredly greater than 50%, preferably greater than 70%, more preferably greater than 90% for the corresponding wavelength. The filter is preferably not transparent for colors other than the predetermined color.

According to a further embodiment of the method, step a) comprises:
sequentially projecting the predetermined pattern in chronologically successive projections, wherein the pattern is projected displaced in relation to one another in different projections.

It can also be said that the pattern is “scanned” over the area. This has the advantage that regions lying between two optical features of the pattern of a projection, in which an object can be arranged that is not captured by the projection, can be captured by one of the following projections since the optical features of the later projection extend through the regions. Scanning of the area using the pattern can thus be sequentially increased. This is advantageous if the predetermined pattern has, for example, a rather large spacing between optical features, for example greater than 11 cm.

Step b) comprises in this case in particular capturing an image of each projection of the pattern and step c) is carried out for each captured image.

According to a further embodiment of the method, step a) comprises:
chronologically sequential projection of multiple different predetermined patterns according to a predetermined sequence.

For example, the sequence comprises a chessboard pattern, a rhomboid pattern, a triangle pattern, and a wave pattern, which are projected in succession.

Step b) comprises in this case in particular capturing an image of each projection of the pattern and step c) is carried out for each captured image.

According to a further embodiment of the method, it comprises:
ascertaining a trajectory for the vehicle on the basis of the digital surroundings map.

The trajectory is ascertained in particular in consideration of objects in the digital surroundings map, in order to avoid a collision.

According to a further embodiment of the method, it comprises:
ascertaining a position of the vehicle on the basis of the projected pattern.

In this embodiment, the projection unit is in particular arranged externally to the vehicle and fixed in place. The vehicle can thus move relative to the projection. Furthermore, the projection of the pattern can capture the vehicle itself. The vehicle can then be ascertainable as an object. Due to the fixed arrangement of the projection unit, the pattern can be projected with a defined specified relative position to the infrastructure. It is thus possible, for example, to project a specific optical feature which appears at a defined fixed position. Fixed coordinates in the digital surroundings map correspond to the fixed position. The respective position of the further optical features can be concluded from a relative position of further optical features to the defined optical feature. Therefore, the position of the vehicle can be concluded from a relative position of the vehicle to the defined optical feature or a further optical feature of the projection, the position of which is defined.

Visually speaking, the fixed projection can be viewed as a coordinate system, through which the vehicle moves, wherein each position in the coordinate system is uniquely assigned to a position in the digital surroundings map.

According to a further embodiment of the method, it comprises:
projecting an optical notification signal.

The optical notification signal can be useful for other road users, for example if it contains a notification that an autonomously controlled vehicle is driving, and can also be used to control the vehicle itself. The notification signal can be used here in terms of a “follow me” function. The vehicle preferably includes sensors for this purpose, which are configured to capture the notification signal, and has a control unit, which is configured to autonomously drive the vehicle according to the captured notification signal.

According to a further embodiment of the method, it comprises:
capturing the projection of the notification signal by means of a camera of the vehicle,
ascertaining information contained in the notification signal, and
operating the vehicle in dependence on the ascertained information.

The information can in particular comprise directional information. Furthermore, the information can comprise a stop signal.

The method of the first aspect can be carried out, for example, in the scenario described hereinafter. In the scenario, the device is arranged in a distributed manner, wherein the projection unit and the capture unit are arranged externally to the vehicle in the infrastructure, which is designed as a parking garage, and the ascertainment unit and the updating unit are arranged in the vehicle, for example as part of the parking assistance system of the vehicle, which is configured for autonomously driving the vehicle. Both the vehicle and the parking garage each include a communication unit and are thus capable of communicating with one another. The user of the vehicle drives with the vehicle to an entry of the parking garage. A communication connection is established and the vehicle registers with the parking garage. In this case, for example, a digital surroundings map, which comprises an outline of the parking garage, is transmitted to the vehicle, as well as a free parking space and a path which leads the vehicle to the free parking space. The user leaves the vehicle and starts the autonomous driving mode. The parking assistance system takes over the control of the vehicle, wherein it ascertains a trajectory which extends along the transmitted path. Movable objects are not included in the digital surroundings map. To avoid a collision with an object, the predetermined pattern is projected in each case in a defined region in front of and/or around the autonomously driving vehicle and the projection is captured. The captured image is transmitted to the ascertainment unit in the vehicle and this ascertains whether an object is located in the area of the projection. Accordingly, the digital surroundings map, on the basis of which the parking assistance system plans the trajectory, is updated. Therefore, in particular movable objects are each currently captured and can be taken into consideration in the planning of the trajectory. The vehicle can therefore safely reach the free parking space autonomously. Upon arriving at the free parking space, the vehicle can park, wherein it uses an ultrasonic sensor for this purpose, for example.

According to a second aspect, a device for operating a parking assistance system for a vehicle is proposed. The parking assistance system is configured for automatically driving the vehicle. The device comprises:
a projection unit for projecting a predetermined pattern on a predetermined area,
a capture unit for capturing an image, wherein at least a portion of the predetermined area having the projection is visible in the captured image,
an ascertainment unit for ascertaining an object arranged in the predetermined area in dependence on the captured image, and
an updating unit for updating a digital surroundings map using the captured object.

This device has the same advantages as described for the method according to the first aspect. The embodiments and features described for the proposed method apply accordingly to the proposed device.

The respective unit, in particular the ascertainment unit and the updating unit, can be implemented in hardware and/or software. In the case of an implementation in hardware, the respective unit may be in the form of a computer or a microprocessor, for example. In the case of an implementation in software, the respective unit may be in the form of a computer program product, a function, a routine, an algorithm, part of a program code, or an executable object. Furthermore, each of the units mentioned here may also be in the form of part of a superordinate control system of the vehicle and/or a building, such as a parking garage. The superordinate control system can be in the form, for example, of a central electronic control unit, such as a server and/or a domain computer, and/or an engine control unit (ECU).

The various units of the device can in particular be arranged in a distributed manner, wherein they have a functional and/or communication connection to one another. The device can comprise a unit integrated in the vehicle, can comprise a unit arranged in the infrastructure, such as a parking garage, for example, and/or can comprise multiple units arranged in a distributed manner.

The vehicle includes a parking assistance system which is operable by means of the device. The parking assistance system can integrate some or all units of the device in this case. The parking assistance system comprises at least one control device, which is configured at least for receiving control signals from the device and for operating the vehicle according to the control signals (remote control of the vehicle).

According to one embodiment of the device, the projection unit is arranged externally to the vehicle, and the capture unit, the ascertainment unit, and the updating unit are arranged in or on the vehicle.

According to a further embodiment of the device, the projection unit and the capture unit are arranged externally to the vehicle and the ascertainment unit and the updating unit are arranged in the vehicle.

In further embodiments, the ascertainment unit is additionally arranged externally to the vehicle, so that only the updating unit is arranged in the vehicle.

According to a third aspect, a parking garage having a device according to the second aspect and having a communication unit for establishing a communication connection to the parking assistance system of the vehicle for transmitting the updated digital surroundings map and/or control signals to the parking assistance system is proposed.

The parking garage is configured to carry out an automated parking process with a vehicle, if the vehicle includes at least one control device, which can also be designated as a parking assistance system, and which is configured at least for receiving control signals from the device and for operating the vehicle according to the control signals (remote control of the vehicle).

Optionally, the parking assistance system of the vehicle can be configured to ascertain a suitable trajectory to a free parking place itself on the basis of the received digital surroundings map and to drive the vehicle autonomously along the trajectory.

According to a fourth aspect, a vehicle is proposed having a parking assistance system for automatically driving the vehicle and having a device according to the second aspect.

This vehicle is in particular capable by way of the device and the parking assistance system of carrying out an automatic parking process. The parking process comprises driving to the free parking space and can comprise parking and departing, wherein the user of the vehicle leaves it, for example, in a transfer region and activates the autonomous parking function. The vehicle then drives autonomously to a free parking space and parks there. Via a call signal, which is received, for example, via a mobile wireless network or another wireless data network, the vehicle can be activated, whereupon it drives from the parking space autonomously to the transfer region, where the user takes it over again. This can also be referred to as an automatic valet parking system.

The vehicle is, for example, an automobile or even a truck. Preferably, the vehicle comprises a number of sensor units which are configured to capture the driving state of the vehicle and to capture the surroundings of the vehicle. In particular, the vehicle comprises a projection unit and a capture unit, which are part of the device. Further examples of sensor units of the vehicle are image capture devices, such as a camera, a radar (radio detection and ranging) or a lidar (light detection and ranging), ultrasonic sensors, location sensors, wheel angle sensors, and/or wheel speed sensors. The sensor units are each configured to output a sensor signal, for example to the parking assistance system or driving assistance system, which carries out the partially autonomous or fully autonomous driving on the basis of the captured sensor signals.

Further possible implementations of the invention also comprise not explicitly mentioned combinations of features or embodiments described above or below with regard to the exemplary embodiments. A person skilled in the art will in this case also add individual aspects as improvements or additions to the respective basic form of the invention.

Further advantageous configurations and aspects of the invention are the subject of the dependent claims and of the exemplary embodiments of the invention that are described below. The invention is explained in more detail below on the basis of preferred embodiments with reference to the accompanying figures.

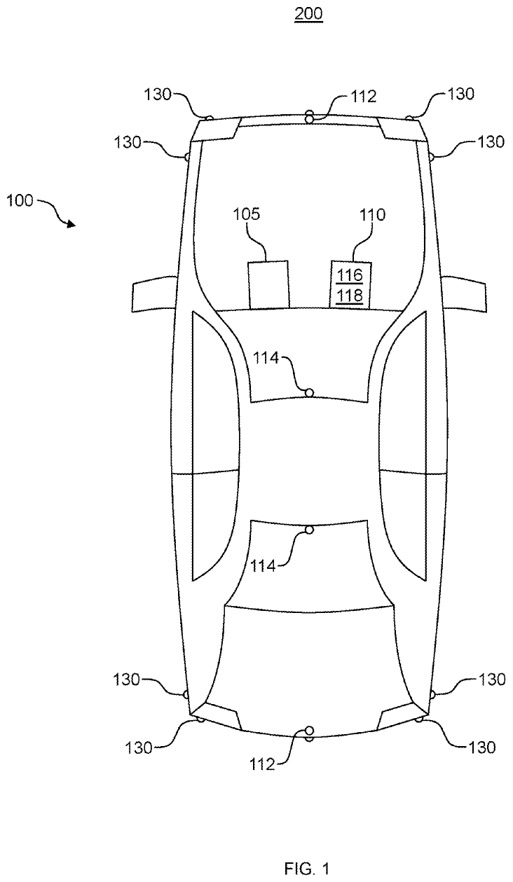

FIG. 1 shows a schematic view of a vehicle from a bird's eye perspective;

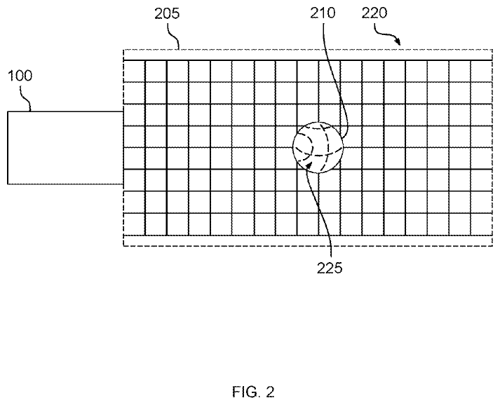

FIG. 2 shows an example of a projection of a predetermined pattern;

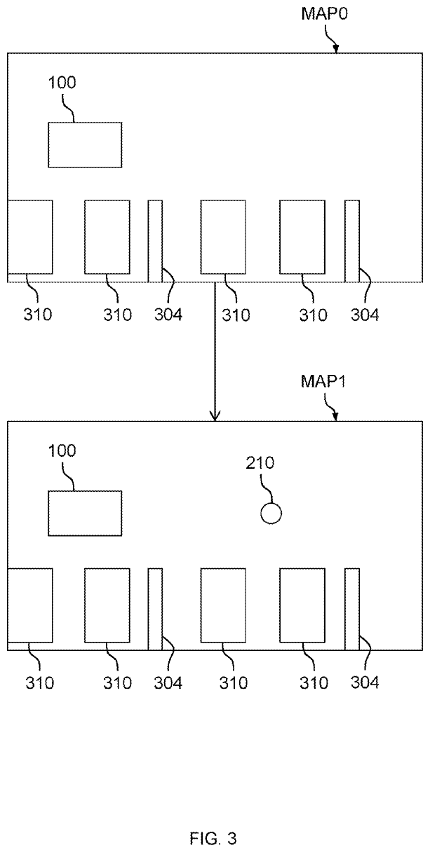

FIG. 3 shows an exemplary embodiment of an update of a digital surroundings map;

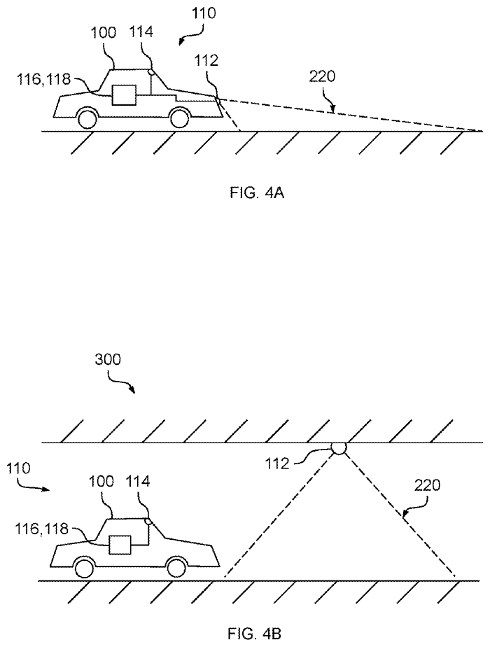

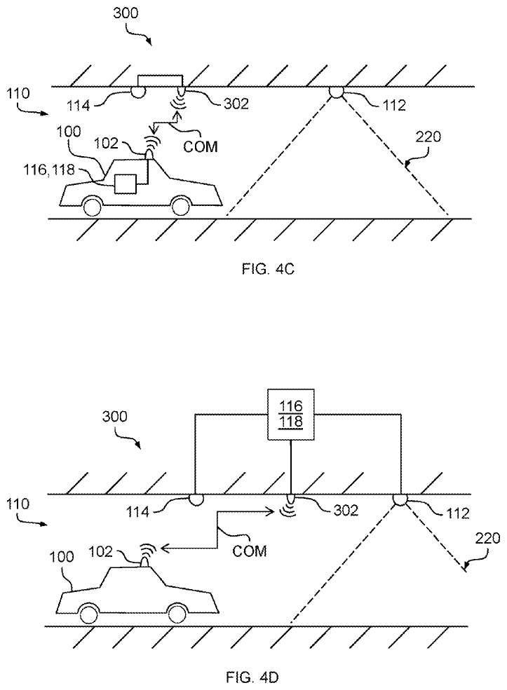

FIGS. 4A-4D show four different exemplary embodiments of a device for operating a parking assistance system;

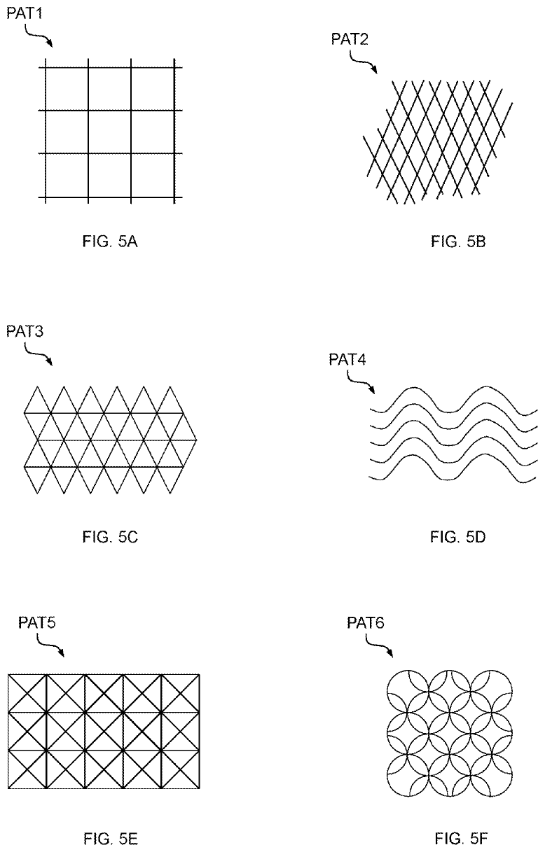

FIGS. 5A-5F show different examples of a predetermined pattern;

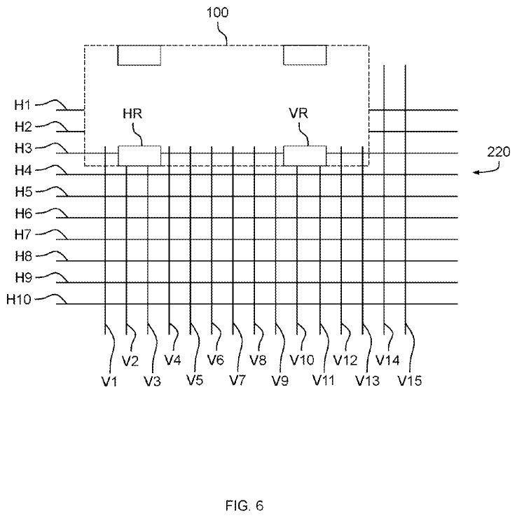

FIG. 6 shows a further example of a projection of a predetermined pattern;

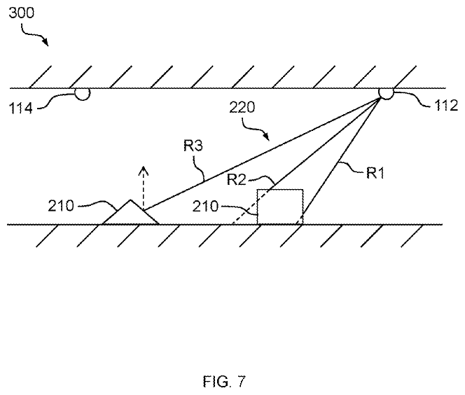

FIG. 7 shows a schematic view of a projection with an obstacle;

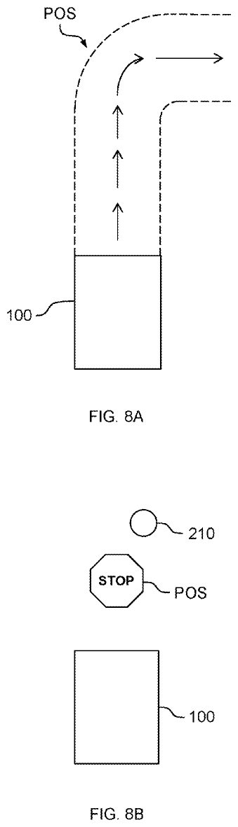

FIGS. 8A-8B show an exemplary embodiment of a projection of an optical notification signal;

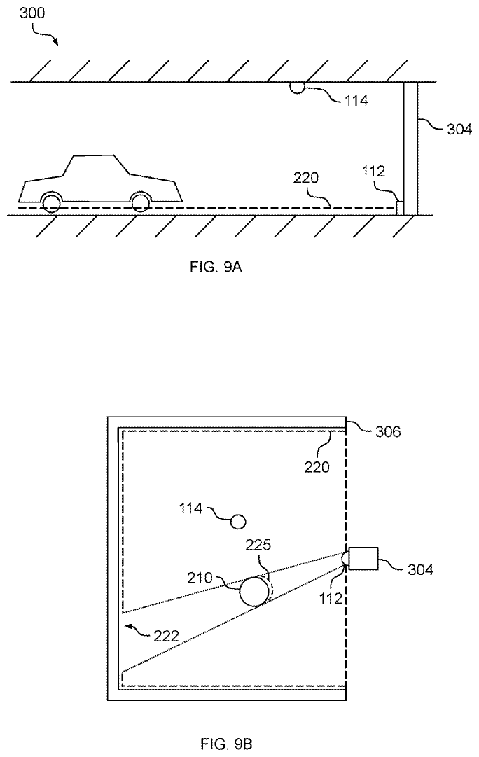

FIGS. 9A-9B each show a schematic view of a further exemplary embodiment for a device for operating a parking assistance system;

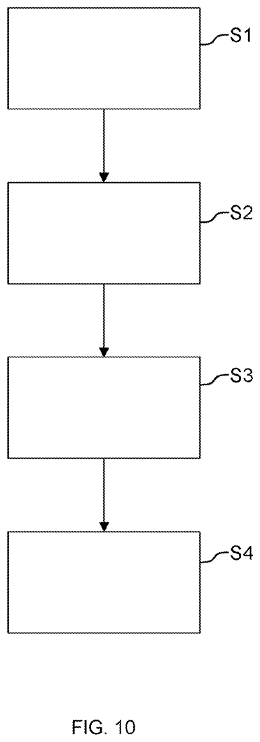

FIG. 10 shows a schematic block diagram of an exemplary embodiment of a method for operating a parking assistance system; and

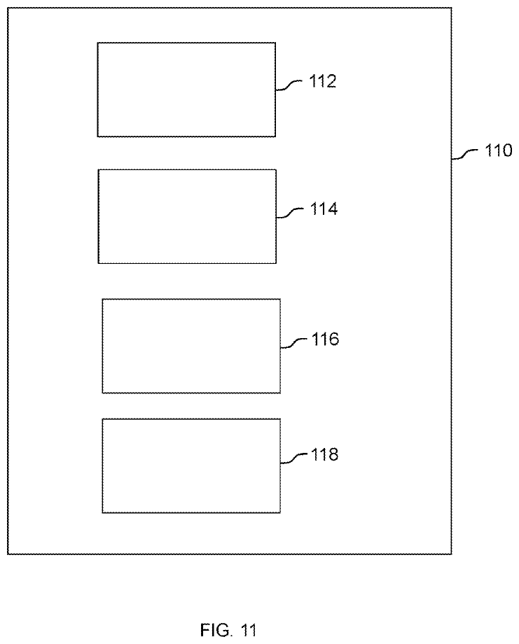

FIG. 11 shows a schematic block diagram of an exemplary embodiment of a device for operating a parking assistance system.

Identical or functionally identical elements have been provided with the same reference signs in the figures, unless stated otherwise.

FIG. 1 shows a schematic view of a vehicle 100 from a bird's eye perspective. The vehicle 100 is, for example, an automobile that is arranged in surroundings 200. The automobile 100 has a parking assistance system 105 that is in the form of a control unit, for example. Furthermore, the vehicle 100 includes a device 110, which is configured for operating the parking assistance system 105. The device 110 comprises in this example two projection units 112, one projection unit 112 directed forward and one projection unit 112 directed to the rear, multiple capture units 114, as well as an ascertainment unit 116 and an updating unit 118. The projection units 112 are in particular in the form of laser projectors and are configured to project a predetermined pattern PAT1-PAT6 (see FIGS. 5A-5F) on a predetermined area 205 (see FIG. 2) by the vehicle 100. The capture units 114 comprise for example visual cameras, a radar, and/or a lidar. The capture units 114 can each capture an image of a respective region from the surroundings 200 of the automobile 100 and output it as an optical sensor signal. In addition, a plurality of surroundings sensor devices 130 are arranged on the automobile 100, wherein these can be, for example, ultrasonic sensors. The ultrasonic sensors 130 are configured to detect a distance from objects arranged in the environment 200 and to output a corresponding sensor signal. By means of the sensor signals captured by the capture units 114 and/or the ultrasonic sensors 130, the parking assistance system 105 and/or the device 110 is able to drive the automobile 100 partially autonomously or even fully autonomously. In addition to the capture units 114 and ultrasonic sensors 130 illustrated in FIG. 1, it can be provided that the vehicle 100 has various other sensor devices. Examples of these are a microphone, an acceleration sensor, a wheel speed sensor, a steering angle sensor, an antenna having a coupled receiver for receiving electromagnetically transmissible data signals, and the like.

The device 110 is designed, for example, as explained in more detail on the basis of FIG. 11 and is configured to carry out the method explained on the basis of FIG. 10.

FIG. 2 shows an example of a projection 220 of a predetermined pattern PAT1-PAT6 (see FIGS. 5A-5F) on a predetermined area 205 by a vehicle 100. For example, this is the vehicle 100 explained on the basis of FIG. 1. The projection 220 can be generated by a projection unit 112 (see FIG. 1, 4, 7, 9, or 11) arranged on the vehicle 100 and/or by a projection unit 112 arranged externally to the vehicle 100. It is to be noted that the projection can also be generated on another predetermined area, independently of the vehicle (not shown), wherein then the projection unit is arranged externally to the vehicle. This example relates, for example, to the predetermined pattern PAT1, which is shown in FIG. 5A. This pattern PAT1 comprises two line families having lines extending in parallel, which are arranged perpendicular to one another. The pattern can also be designated as a chessboard pattern. On a planar area, the projection 220 of the predetermined pattern PAT1 corresponds to the predetermined pattern PAT1, i.e., the lines extend in parallel and perpendicular to one another. At points at which the surface on which the pattern is projected extends in curved lines, for example, because an object 210 is located there, however, the projection 220 no longer necessarily corresponds to the predetermined pattern PAT1. This is shown by way of example in FIG. 2, wherein the projection 220 appears distorted in the area of the object 210, as shown by the lines 225 extending in curves.

The projection 220 of the pattern is captured as an image, for example, by means of a capture unit 112 (see FIG. 1, 4, 7, 9, or 11) arranged on the vehicle 100. It may be ascertained on the basis of the distortion of the pattern 225 that an object 210, which causes this distortion, has to be located in the corresponding region. An ascertainment unit 116 (see FIG. 1, 4, 7, 9, or 11) is accordingly configured to ascertain the object 210 on the basis of the captured image.

In embodiments (not shown) it can be provided that a shape of the object 210 is concluded on the basis of the distortion of the pattern 225. Alternatively or additionally, an object classification can also be carried out (not shown) on the basis of the distortion 225, wherein this is preferably carried out by means of a neural network, in particular by means of a GAN (generative adversarial network) and/or by means of a CNN (convolutional neural network).

FIG. 3 shows an exemplary embodiment of an update of a digital surroundings map MAP0, MAP1. The digital surroundings map MAP0, MAP1 is a representation of the actual surroundings 200 (see FIG. 1) of the vehicle 100 at a defined point in time, wherein the digital surroundings map MAP0, MAP1 comprises some or all captured features of the surroundings 200 as needed. In the example of FIG. 3, the digital surroundings map MAP0, MAP1 shows a bird's eye perspective of the surroundings 200.

In this example, the vehicle 100 is located, for example, in a parking garage, wherein parked vehicles 310 and columns 304 are present in the digital surroundings map MAP0. In embodiments, it can be provided that the digital surroundings map MAP0, MAP1 is specified at least partially by a system arranged externally to the vehicle 100, such as a parking guidance system. The specified digital surroundings map MAP0 comprises, for example, an outline of the parking garage, wherein lanes and building structures, such as the columns 304, are already contained therein.

The vehicle 100 is, for example, autonomously controlled by a parking assistance system 105 (see FIG. 1) of the vehicle 100, wherein the parking assistance system 105 is operable by a device 110 (see FIG. 1 or 11). For example, as explained on the basis of FIG. 2, it is ascertained on the basis of a captured image of a projection 220 (see FIG. 2) by an ascertainment unit 116 (see FIG. 1, 4, 7, 9, or 11) that an object 210 is located in front of the vehicle 100. An updating unit 118 (see FIG. 1, 4, 7, 9, or 11) thereupon updates the digital surroundings map MAP0, wherein the updated surroundings map MAP1 contains the ascertained object 210. A collision of the autonomously driving vehicle 100 with the object 210 can thus be avoided.

FIGS. 4A-4D show four different exemplary embodiments of a device 110 for operating a parking assistance system 105 (see FIG. 1) for a vehicle 100. In all four examples, the device 100 comprises a projection unit 112, a capture unit 114, an ascertainment unit 116, and an updating unit 118. The respective projection unit 112 is configured to project 220 a predetermined pattern PAT1-PAT6 (see FIGS. 5A-5F) on a predetermined area 205 (see FIG. 2), in particular an area by the vehicle 100, and the capture unit 114 is configured to capture an image of the projection 220. The ascertainment unit 116 is configured to ascertain an object 210 (see FIG. 2 or 3) in dependence on the captured image, and the updating unit 118 is configured to update a digital surroundings map MAP0, MAP1 (see FIG. 3).

FIG. 4A shows a first embodiment, in which the device 110 having all units is arranged on the vehicle 100. This can also be referred to as a “standalone” solution.

FIG. 4B shows a second embodiment, in which the projection unit 112 is arranged externally to the vehicle 100, in the infrastructure. The infrastructure is in this example a parking garage 300 and the projection unit 112 is arranged in particular on a ceiling of the parking garage 300.

FIG. 4C shows a third embodiment, in which the projection unit 112 and the capture unit 114 are arranged externally to the vehicle 100 in the infrastructure. The infrastructure is in this example a parking garage 300 and the projection unit 112 and the capture unit 114 are arranged offset to one another on a ceiling of the parking garage 300. Due to the offset arrangement, a parallax results between the projection unit 112 and the capture unit 114, which improves the capture of objects. In addition, in this example the vehicle 100 and the parking garage 300 have a respective communication unit 102, 302, which are configured to establish a wireless communication connection COM with one another. In this example, in particular the image captured by the capture unit 114 is transmitted via the communication connection COM, so that the ascertainment unit 116 arranged in the vehicle can ascertain objects 210 (see FIG. 2 or 3) in dependence on the captured image.

FIG. 4D shows a fourth embodiment, in which the device 100 as a whole is arranged in the infrastructure. As in FIG. 4C, in this example the vehicle 100 and the parking garage 300 have a respective communication unit 102, 302, which are configured to establish a wireless communication connection COM with one another. In this case, however, instead of the captured image, for example, the updated surroundings map MAP0, MAP1 (see FIG. 3) is transmitted to the vehicle 100. The vehicle 100 or a parking assistance system 105 (see FIG. 1) of the vehicle 100 is configured to ascertain a trajectory on the basis of the digital surroundings map MAP0, MAP1, for example, in order to reach a free parking space. Alternatively, the trajectory for the vehicle 100 can also be ascertained by a corresponding unit in the infrastructure and only control signals are transmitted to the vehicle 100 (remote control of the vehicle 100).

FIGS. 5A-5F show different examples of a predetermined pattern PAT1-PAT6.

The predetermined pattern PAT1 in FIG. 5A is, for example, a chessboard pattern. The predetermined pattern PAT2 in FIG. 5B is, for example, a rhomboid pattern. The predetermined pattern PAT3 in FIG. 5C is, for example, a triangle pattern. The predetermined pattern PAT4 in FIG. 5D is, for example, a wave pattern. The predetermined pattern PAT5 in FIG. 5E is, for example, a further triangle pattern. The predetermined pattern PAT6 in FIG. 5F is, for example, a circle pattern.

It is to be noted that the predetermined patterns shown on the basis of FIGS. 5A-5F are solely by way of example. Any other predetermined patterns are conceivable, such as, for example, combinations of the predetermined patterns PAT1-PAT6. The predetermined patterns PAT1-PAT6 are projected in particular such that a spacing of adjacent optical features, for example a line spacing of two adjacent lines, is at most 11 cm in a static projection.

In a dynamic projection, i.e., the projection is displaced at defined time intervals and/or different patterns are projected in different time intervals, a line spacing of a single pattern can also be greater than 11 cm. A line spacing of two successive patterns is preferably at most 11 cm, i.e., when the chronologically successive projected patterns are superimposed, the maximum line spacing is 11 cm. It is therefore ensured that objects which are at least 11 cm in size are captured by the projection 220 and are thus ascertainable by the device 110.

FIG. 6 shows a further example of a projection 220 of a predetermined pattern PAT1-PAT6 (see FIGS. 5A-5F), wherein this is, for example, the chessboard pattern PAT1 of FIG. 5A. In this example it will be explained how the projection 220 of the pattern can be used to assist locating the vehicle 100. Locating the vehicle 100 in enclosed spaces, such as a parking garage 300 (see FIG. 4B-4D or 9) is difficult due to the absence of a position signal, such as a GPS, because of which it is particularly advantageous to ascertain the position of the vehicle 100 in the parking garage 300 as described hereinafter. In this example, the projection unit 112 (see FIG. 1, 4, 7, 9, or 11) is arranged fixed in place in the infrastructure, thus, for example, as shown on the basis of FIGS. 4B-4D.

Due to the fixed arrangement of the projection unit 112, the pattern can be projected with a defined specified relative position to the infrastructure. It is thus possible, for example, to project a line which has precisely a predetermined spacing, such as two meters, from a side wall. In FIG. 6, the lines of the projection 220 are numbered with H1-H10 and V1-V15. For example, the location of each line is specified in the digital surroundings map MAP0, MAP1 (see FIG. 3). On the basis of the horizontal lines H1-H10, a position in a transverse direction of the vehicle 100 can be ascertained and on the basis of the vertical lines V1-V15, a position in a longitudinal direction of the vehicle 100 can be ascertained.

When the vehicle 100 now moves along the projection 220, it passes over the fixed lines of the pattern. That is to say, a part of the projection 220 is not generated on the ground but rather is on the vehicle 100 (not shown for reasons of clarity). Moreover, FIG. 6 shows that the projection 220 protrudes at some points below the body of the vehicle 100, wherein this is dependent on a height of the body above the ground and a projection angle of the projection 220 relative to the vehicle 100. In particular at the wheels HR, VR of the vehicle 100 which touch the ground, exact locating is possible since the transition point at which the projection 220 changes from the ground to the respective wheel HR, VR precisely marks the current position of the respective wheel HR, VR of the vehicle 100.

In this example, the position of the front wheel VR in the longitudinal direction is ascertained on the basis of the lines V10 and V11, wherein the ascertained position corresponds to a value between the positions of the lines V10 and V11, and the position of the rear wheel HR in the longitudinal direction is ascertained on the basis of the lines V2 and V3, wherein the ascertained position corresponds to a value between the positions of the lines V2 and V3. The position of the vehicle 100 in the transverse direction is ascertained on the basis of the lines H3 and H4 for the right vehicle side, wherein the ascertained position corresponds to a value between the positions of the lines H3 and H4.

The locating can be carried out using a capture unit 114 (see FIG. 1, 4, 7, 9, or 11) arranged on the vehicle 100 or also using a capture unit 114 arranged fixed in place in the infrastructure. If the capture unit 114 is arranged on the vehicle 100, it is then necessary for at least one of the projected optical features to be identified so that it can be distinguished from the others. This optical feature can then be ascertained in the captured image of the projection 220, wherein a position corresponding to the position of the optical feature is defined and specified in the digital surroundings map MAP0, MAP1. The relative position of the vehicle 100 to the optical feature can then be ascertained and thus also the absolute position of the vehicle 100 in the digital surroundings map MAP0, MAP1.

FIG. 7 shows a schematic view of a projection 220 having two obstacles 210. The projection unit 112 is located in this example on a ceiling of a parking garage 300. The capture unit 114 is arranged at another position on the ceiling of the parking garage 300. FIG. 7 is used to explain how a respective position 210 can change the projection 220 of a predetermined pattern PAT1-PAT6 (see FIGS. 5A-5F).

A first beam R1 of the projection 220 is incident laterally on the object 210. The side of the object 210 is not visible from the perspective of the capture unit 114. The optical feature which is to be generated by the first beam R1 on the floor of the parking garage 300 is therefore not included in the image of the projection 220, from which the presence of the object 210 may be concluded.

A second beam R2 of the projection 220 is incident on an upper side of the object 210, which is visible from the capture unit. The optical feature which is to be generated by the second beam R2 on the floor of the parking garage 300 therefore appears displaced in relation to the expected position. It can also be said that the projection 220 appears distorted in this region in relation to the predetermined pattern PAT1-PAT6. The presence of the object 210 may be concluded therefrom.

A third beam R3 of the projection 220 is incident on an inclined surface of an object 210. A reflection angle of the beam R3 is thus influenced, which is noticeable, for example, due to a changed brightness of the optical feature which is to be generated by the third beam R3. The presence of the object 210 may be concluded therefrom.

The three mentioned examples do not form an exhaustive list of the optical effects on the basis of which an object 210 is ascertainable in the image of a projection 220 of a predetermined pattern PAT1-PAT6, but are used solely for illustration.

FIGS. 8A-8B show an exemplary embodiment of a projection of an optical notification signal POS, which comprises defined information. In this example, the projection unit 112 is arranged externally to the vehicle 100 and the vehicle 100 includes a capture unit 114, using which it captures the optical notification signal POS. A parking assistance system 105 (see FIG. 1) of the vehicle 100 is configured to ascertain the information contained in the optical notification signal POS on the basis of the captured image and to control the vehicle 100 autonomously in dependence on the information.

In FIG. 8A, the optical notification signal POS is used in particular to display to the vehicle 100 an ascertained trajectory along which the vehicle 100 is to drive. The parking assistance system 105 is configured to drive the vehicle 100 autonomously along the displayed trajectory.

The optical notification signal POS can in particular also unfold a signal effect for other road users. For example, the dashed lines of the optical notification signal POS indicate the lane of the autonomously driving vehicle 100. Other road users are therefore warned that it is an autonomously driving vehicle 100 and can keep the lane of the vehicle 100 free. In embodiments (not shown), it can be provided that a visually clearly perceptible optical notification signal POS is projected in a predetermined area around the vehicle 100, which clearly indicates the autonomously driving vehicle 100.

In FIG. 8B, the optical notification signal POS is used in particular to stop the vehicle in front of an ascertained object 210 in order to avoid a collision with the object 210. The parking assistance system 105 is configured to stop the vehicle 100 according to the optical notification signal POS.

FIGS. 9A-9B each show a schematic view of a further exemplary embodiment for a device 110 for operating a parking assistance system 105 (see FIG. 1) for a vehicle 100. FIG. 9A shows a side view, FIG. 9B shows a view from above, wherein the vehicle 100 is located in a parking garage 300. In this example, the projection unit 112 is arranged externally to the vehicle 100 and just above the roadway on a column 304, for example, at a height of 1-5 cm. The capture unit 114 is arranged on the ceiling of the parking garage 300.

The projection unit 112 in this example projects only one line as the predetermined pattern PAT1-PAT6 (see FIGS. 5A-5F), wherein the light propagates just above the ground. A reflector 306 is arranged on the ground at a predetermined position, on which the light is incident and from which it is reflected. The reflector 306 has, for example, a height corresponding to the height of the projection unit 112. If the area between the projection unit 112 and the reflector is free of objects 210, the projection 220 is then a line which extends along the course of the reflector 306.

However, if an object 210 is located in the area, the light is then incident on the object and is reflected from it. This is recognizable as a distorted pattern 225 in the image of the projection 220. Moreover, a shadowing 222 results in an area of the reflector 306 which corresponds to an alignment from the projection unit 112 via the object 210. The presence of the object 210 can therefore be concluded.

FIG. 10 shows a schematic block diagram of an exemplary embodiment of a method for operating a parking assistance system 105, for example the parking assistance system 105 of the vehicle 100 of FIG. 1. In a first step S1, a predetermined pattern PAT1-PAT6 (see FIGS. 5A-5F) is projected on a predetermined area 205 (see FIG. 2), in particular an area by the vehicle 100 (see FIG. 1-4, 6, 8, or 9). In a second step S2, an image of the surroundings 200 (see FIG. 1) of the vehicle 100 is captured, wherein at least a portion of the predetermined area 205 with the projection 220 (see FIG. 2, 4, or 6-9) is visible in the captured image. In a third step S3, an object 210 (see FIG. 2, 3, 7, or 9) arranged in the predetermined area (205) is ascertained in dependence on the captured image. In a fourth step S4, a digital surroundings map MAP0, MAP1 (see FIG. 3) is updated using the captured object 210.

FIG. 11 shows a schematic block diagram of an exemplary embodiment of a device 110 for operating a parking assistance system 105, for example the parking assistance system 105 of the vehicle 100 of FIG. 1. The device 110 comprises a projection unit 112 for projecting a predetermined pattern PAT1-PAT6 (see FIGS. 5A-5F) on a predetermined area 205 (see FIG. 2), in particular an area by the vehicle 100, a capture unit 114 for capturing an image of the surroundings 200 (see FIG. 1) of the vehicle 100, wherein at least a portion of the predetermined area 205 having the projection 220 (see FIG. 2, 4, or 6-9) is visible in the captured image, an ascertainment unit 116 for ascertaining an object 210 arranged in the predetermined area 205 (see FIG. 2, 3, 7, or 9) in dependence on the captured image, and an updating unit 118 for updating a digital surroundings map MAP0, MAP1 using the captured object 210.

The device 110 is configured in particular to carry out the method described on the basis of FIG. 10.

Although the present invention has been described on the basis of exemplary embodiments, it may be modified in many ways.

### LIST OF REFERENCE SIGNS

100 vehicle
102 communication unit
105 parking assistance system
110 device
112 projection unit
114 capture unit
116 ascertainment unit
118 updating unit
130 sensor
200 surroundings
205 area
210 object
220 projection
222 shadowing
225 distorted pattern
300 parking garage
302 communication unit
304 obstacle
306 reflector
310 parked vehicle
COM communication connection
H1-H10 lines
HR rear wheel
MAP0 digital surroundings map
MAP1 digital surroundings map
PAT1 predetermined pattern
PAT2 predetermined pattern
PAT3 predetermined pattern
PAT4 predetermined pattern
PAT5 predetermined pattern
PAT6 predetermined pattern
POS optical notification signal
R1 light beam
R2 light beam
R3 light beam
S1 method step
S2 method step
S3 method step
S4 method step
V1-V15 lines
VR front wheel

1. A method for operating a parking assistance system for a vehicle, the method comprising:
a) projecting a predetermined pattern on a predetermined area by the vehicle;
b) capturing an image, wherein at least a portion of the predetermined area having the projection is visible in the captured image;
c) ascertaining an object arranged in the predetermined area in dependence on the captured image; and
d) updating a digital surroundings map using the captured object.

2. The method as claimed in claim 1, wherein step c) comprises:
capturing a distortion of the projected pattern in the captured image.

3. The method as claimed in claim 1, wherein step a) comprises:
projecting the predetermined pattern using a laser projector.

4. The method as claimed in claim 1, wherein step a) comprises:
projecting the predetermined pattern using a predetermined color. and step b) comprises:
capturing the image using a filter which is transparent for the predetermined color.

5. The method as claimed in claim 1, wherein step a) comprises:
sequentially projecting the predetermined pattern in chronologically successive projections, wherein the pattern is projected displaced in relation to one another in different projections.

6. The method as claimed in claim 1, wherein step a) comprises:
chronologically sequentially projecting multiple different predetermined patterns (PAT1-PAT6) according to a predetermined sequence.

7. The method as claimed in claim 1, characterized by ascertaining a trajectory for the vehicle on the basis of the digital surroundings map.

8. The method as claimed in claim 1, characterized by ascertaining a position of the vehicle (100) on the basis of the projected pattern.

9. The method as claimed in claim 1, characterized by projecting an optical notification signal.

10. The method as claimed in claim 9, further comprising:
capturing the projection of the notification signal by a camera of the vehicle;
ascertaining information contained in the notification signal; and
operating the vehicle in dependence on the ascertained information.

11. A device for operating a parking assistance system for a vehicle, wherein the parking assistance system is configured for automatically driving the vehicle, the device comprising:
a projection unit for projecting a predetermined pattern on a predetermined area by the vehicle;
a capture unit for capturing an image, wherein at least a portion of the predetermined area having the projection is visible in the captured image;
an ascertainment unit for ascertaining an object arranged in the predetermined area in dependence on the captured image, and
an updating unit for updating a digital surroundings map using the captured object.

12. The device as claimed in claim 11, wherein the projection unit is arranged externally to the vehicle, and that the capture unit, the ascertainment unit, and the updating unit are arranged in the vehicle.

13. The device as claimed in claim 11, wherein the projection unit and the capture unit are arranged externally to the vehicle, and that the ascertainment unit and the updating unit are arranged in the vehicle.

14. A parking garage having a device as claimed in claim 11 and having a communication unit for establishing a communication connection to the parking assistance system of the vehicle for transmitting the updated digital surroundings map and/or control signals to the parking assistance system.

15. A vehicle having a parking assistance system for automatically driving the vehicle and having a device as claimed in claim 11.
